(19) United States
(12) Patent Application Publication
(10) Pub. No.: US 2022/0405215 A1
(43) Pub. Date: Dec. 22, 2022

(54) METHOD FOR ACCESSING FLASH MEMORY AND FLASH MEMORY CONTROLLER AND ELECTRONIC DEVICE THEREOF

(71) Applicant: SILICON MOTION, INC., Zhubei City (TW)

(72) Inventors: Hsu-Ping OU, Zhubei City (TW); Tsu-Han LU, Zhubei City (TW)

(73) Assignee: SILICON MOTION, INC., Zhubei City (TW)

(21) Appl. No.: 17/463,542

(22) Filed: Aug. 31, 2021

(30) Foreign Application Priority Data
Jun. 18, 2021 (TW) 110122458

(51) Int. Cl. G06F 13/16; G06F 13/40; G06F 12/02; G06F 12/0882

(52) U.S. Cl. CPC G06F 13/1673; G06F 13/4068; G06F 12/0246; G06F 12/0882

(57) ABSTRACT

Disclosed is a method for accessing data from a flash memory. The method comprises a flash memory controller receiving an access command from a host device, according to the access command, the flash memory accessing a plurality of data from the data pages of a plurality of blocks in the flash memory simultaneously and simultaneously temporarily storing the accessed data to the plurality of buffers of the flash memory, and simultaneously temporarily storing the data in the plurality of buffers of the flash memory buffer to the plurality of buffers the flash memory controller.

### CROSS-REFERENCE TO RELATED APPLICATION

This application claims the priority benefit of Taiwanese Patent Application Serial Number 110122458, filed on Jun. 18, 2021, the full disclosure of which is incorporated herein by reference.

### BACKGROUND

### Technical Field

The present disclosure relates to the technical field of flash memory, particularly to a method for accessing flash memory, a flash memory controller, and an electronic device.

### Related Art

Conventional flash memory device often comprises a controller and a flash memory for storing data for a host device. When the host device wishes to store data to the flash memory device, it would send a writing command to the flash memory device, then the controller would write the data to the flash memory according to the writing command. When the host device wishes to access data from the flash memory device, it would send an access command to the flash memory device, then the controller would access the data from the flash memory according to the access command and send the data to the host device.

The flash memory accessing shows that it takes “data page” as a basic unit during writing while taking “block” as a basic unit during erasing. At present, the accessing unit of conventional flash memory is smaller than the data page size, for example, the data page size can be 16 KB, and the accessing unit is 4 KB. Thus, every time accessing a command requires a waiting period for a Read Busy time. When the smallest unit of random access is smaller than the data page size of the flash memory, and the multiple data accessed are in different blocks and different pages of the same plane, it would take up multiple Read Busy times that significantly lowers the flash memory efficiency.

### SUMMARY

The embodiments of the present disclosure provide a method for accessing flash memory, a flash memory controller, and an electronic device tended to solve the problem of poor data accessing performance of flash memory.

In one embodiment of the present disclosure, a method for accessing a flash memory is provided. The flash memory is electrically connected to a host device through a flash memory controller. The flash memory comprises a memory buffer and a plurality of blocks. Each of the plurality of blocks comprises a plurality of data pages. The memory buffer of the flash memory comprises a plurality of memory buffer areas. Each of the plurality of blocks comprises a plurality of data pages. The flash memory controller comprises a controller buffer. The controller buffer of the flash memory controller comprises a plurality of controller buffer areas. The method for accessing flash memory comprising: the flash memory controller receiving an accessing command from the host device; based on the accessing command, simultaneously accessing a plurality of data from at least one of the plurality of data pages in the plurality of blocks, wherein the accessed plurality of blocks is on the same plane of different dies of the flash memory, the size of the plurality of data is smaller than the size of the data page; simultaneously caching the accessed plurality of data to the plurality of memory buffer areas of the memory buffer of the flash memory; accessing the plurality of data temporarily stored in the plurality of memory buffer areas of the memory buffer of the flash memory into the controller buffer area of the controller buffer of the flash memory controller at a time.

In another embodiment of the present disclosure, a flash memory controller is provided, wherein the flash memory controller accesses a flash memory. The flash memory comprises a memory buffer and a plurality of blocks. The memory buffer comprises a plurality of memory buffer areas. Each of the blocks comprises a plurality of data pages. The flash memory controller comprises a read only memory storing a program code and a processing circuit executing the program code to control the access to the flash memory, wherein the processing circuit: receive an access command from a host device; based on the accessing command, simultaneously access a plurality of data from at least one of the plurality of data pages in the plurality of blocks, wherein the accessed plurality of blocks is on the same plane of different dies of the flash memory, the size of the plurality of data is smaller than the size of the data page; simultaneously and temporarily store the accessed plurality of data to the plurality of memory buffer areas of the memory buffer of the flash memory in order; access the plurality of data temporarily stored in the plurality of memory buffer areas of the memory buffer of the flash memory into the controller buffer area of the controller buffer of the flash memory controller at a time.

In another embodiment of the present disclosure, an electronic device is provided, which comprises a flash memory module and a flash memory controller accessing the flash memory module. The flash memory comprises a memory buffer and a plurality of blocks. The memory buffer comprises a plurality of memory buffer areas. Each of the blocks comprises a plurality of data pages. The flash memory controller comprises a controller buffer. The controller buffer of the flash memory controller comprises a plurality of controller buffer areas, wherein the flash memory controller: receive an access command from a host device; based on the accessing command, simultaneously accessing a plurality of data from at least one of the plurality of data pages in the plurality of blocks, wherein the accessed plurality of blocks is on the same plane of different dies of the flash memory, the size of the plurality of data is smaller than the size of the data page; simultaneously caching the accessed plurality of data to the plurality of memory buffer areas of the memory buffer of the flash memory; access the plurality of data temporarily stored in the plurality of memory buffer areas of the memory buffer of the flash memory into the controller buffer area of the controller buffer of the flash memory controller at a time.

In the prior art, every data accessing must wait until the last data access is stored into the buffer area of the flash memory controller before continuing to access the next data of the flash memory, which is time consuming. The flash memory data access method of the present disclosure is first to temporarily store all the accessed data in a buffer area of the flash memory. When all data are accessed, the data is accessed again to the buffer area of the flash memory controller. Thus, the accessing efficiency of the memory can be significantly improved.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of a flash memory of an embodiment of the present disclosure;

FIG. 2 is a flow chart of a flash memory controller of the embodiment of FIG. 1 accessing a plurality of data; and

FIG. 3 is a schematic diagram showing the accessing to a plurality of data of a flash memory of an embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

It should be noted that as an element is described in a relationship with one another as “connected” or “coupled” that can be a direct link or an indirect link with an intermediate element exists. When the link is described as “direct connection” or “direct coupling”, the intermediate element would not be existed.

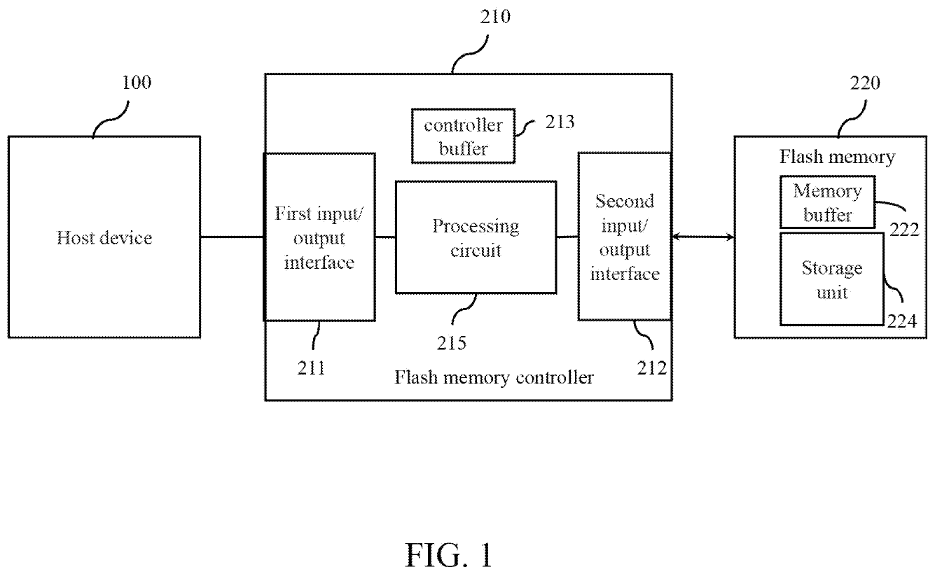

FIG. 1 is a block diagram of a flash memory of an embodiment of the present disclosure. A flash memory controller 210 is configured to be disposed between and connected with a host device 100 and a flash memory 220. The flash memory controller 210 and the flash memory 220 could form a storage device or be disposed in an electronic device, wherein the flash memory controller is used to access the flash memory, which can be, for example, a NAND flash memory (but not limited hereto). The flash memory controller 210 and the flash memory 220 can be included in a portable storage device (for example, a memory card compliant with SD/MMC, CF, MS, XD standards), for example, a thumb drive, a pen drive, a stick, or a disk. A host device 100 can be an electronic device connected to a storage device, such as a mobile phone, a laptop computer, a desktop computer, etc. In another embodiment, the storage device can be a solid state drive or an embedded storage device compliant with Universal Flash Storage (UFS) or Embedded Multi Media Card (EMMC) specifications to be installed in an electronic device, such as a mobile phone, a laptop computer, a desktop computer, a video recording device, or a dash camera. The host device 100 herein could be a processor of the electronic device.

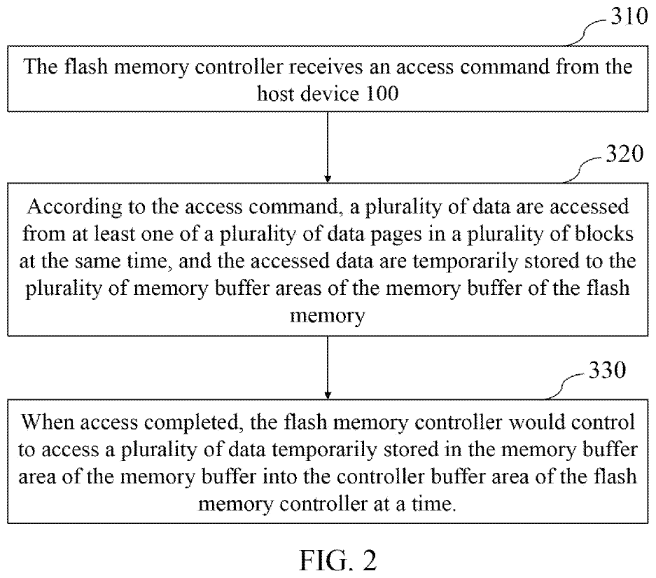

The flash memory controller 210 comprises a first input/output interface 211, a second input/output interface 212, a processing circuit 215, and a read only memory. The read only memory stores a program code. The processing circuit 215 executes the program code to control the access to the flash memory 220, that is, to execute the method described in FIG. 2. The flash memory 220 comprises at least one storage unit 224 and at least one corresponding memory buffer 222. For example, when the flash memory 220 is a two-plane type flash memory, the flash memory 220 would comprise two storage units and two memory buffers.

Alternatively, the flash memory 220 comprises a plurality of flash memory chips. Each of the flash memory chips comprises a plurality of dies. Each of the flash memory chips comprises a plurality of blocks. The flash memory controller 210 erases data from the flash memory 220 in units of blocks. Besides, a block could record a specific number of data pages, wherein the flash memory controller 210 writes data to the flash memory 220 in units of data pages. For example, each flash memory chip comprises 8 dies, each die comprises 2 planes, each plane comprises 1024 blocks, and each block comprises 512 data pages, wherein the size of each page is 16 KB. In the method for accessing the memory of the present disclosure, the plurality of accessed blocks are on the same plane of different dies of the flash memory, and the size of the plurality of data is smaller than the size of the data page.

The first input/output interface 211 is configured to connect with a signal port of the host device 100 through a bus (such as a USB bus, but not limited hereto) to receive commands or a plurality of data units sent from the host device 100. The second input/output interface 212 is configured to connect with the flash memory 220 through an internal bus. The processing circuit 215 is coupled between the first input/output interface 211 and the second input/output interface 212, and is configured to program or write one or more than one data unit from the host device 100 to the flash memory 220, or is configured to access one or more than one data units stored in the storage unit 224 of the flash memory 220 according to the access command.

The processing circuit 215 could comprise an error correction code encoding/decoding circuit, a microcontroller, one or more than one buffers, one or more caches, one or more registers, an encryption/decoding engine, and/or a control finite stage machine. In one embodiment, since the processing circuit 215 executes the program code stored in the read only memory of the flash memory controller, the flash memory controller 210 could control the access to the flash memory 220, for example, using a microcontroller to control the access operation of the flash memory 220 (particularly the access operation to at least one block or at least one data page); or enabling the flash memory controller 210 to use these components for other controls, for example, using one or more than one buffers for the required buffering. The buffer can be implemented with random access memory (RAM). For example, a static random access memory (Static RAM, SRAM), but the present disclosure is not limited thereto.

The data size of a data unit transmitted from the host device 100 and output to the flash memory controller 210 could be different from the data size of a page of data defined in the flash memory 220. In this embodiment, a data unit transmitted and output from the host device 100 can be considered as a management data unit, and the data size of the data unit can be different and could vary depending on different applications, such as video, audio, or other applications of the host device 100. In one embodiment, the data of the management data unit can be designed in a size of 4 KB (but not limited hereto). Moreover, a storage page data refers to a unit of data for data programming/writing to the flash memory 220. For example, a storage page data can be 16 KB sized in a one plane type flash memory and can be 32 KB sized in a double plane type flash memory. That is, in this embodiment, the host device 100 would send or transmit a series of multiple data units with a data size of 4 KB to the flash memory controller 210 through the USB bus in order. For example, the host device 100 could be a portable device capable of acquiring high quality images/videos and can transfer and write the acquired data in order to the flash memory to avoid errors that could be lost due to a data burst. It should be noted that this should not be a limitation to the present disclosure, the host device 100 can be used for different devices or different purposes in different embodiments. The data size of a management data unit is not limited to the size of 4 KB, in other embodiments, the data size can also be designed in a size of 1 KB, 2 KB or depending on the system design. Furthermore, when the data size of a management data unit is 4 KB, and the data size of a storage page data is 16 KB, a four management data units would form a storage page data. In other words, a management data unit sent and output from the host device 100 can be considered as a part of the data of the storage page data stored in a storage page data unit of the flash memory 220.

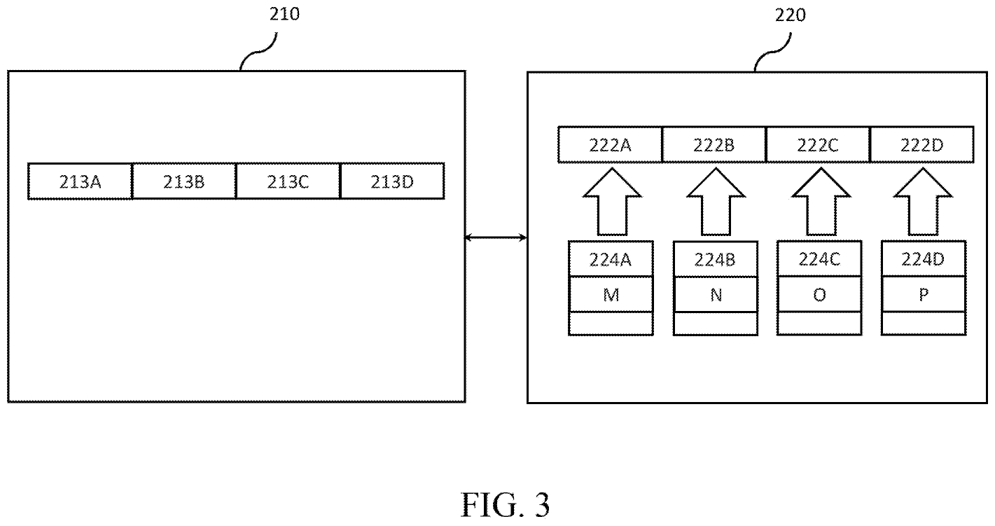

FIG. 2 is a flow chart of a flash memory controller of the embodiment of FIG. 1 accessing a plurality of data. When the same result can be achieved, it is not necessary to follow the steps shown in FIG. 2, and the steps of FIG. 2 need not to be continuously performed, that is, steps other than the shown ones can also be performed in between any two steps. The data accessing method of the flash memory shown in FIG. 2 is used to access data by the flash memory thereof according to an access command from the host device 100. FIG. 3 is a schematic diagram showing the accessing to a plurality of data of a flash memory of an embodiment of the present disclosure. As shown in FIG. for FIG. 3, the flash memory 220 comprises a memory buffer 222 and a plurality of blocks 224A, 224B, 224C, and 224D. The memory buffer 222 comprises a plurality of memory buffer areas 222A, 222B, 222C, and 222D. The blocks 224A, 224B, 224C, and 224D respectively comprise a plurality of data pages and are on the same plane of different dies of the flash memory. FIG. 3 shows one of the data pages in the block as an example. The controller buffer 213 of the flash memory controller 210 further comprises a plurality of controller buffer areas 213A, 213B, 213C, and 213D.

The processing steps of the flash memory data accessing method are described as follows. First, the flash memory controller 210 receives an access command from the host device 100 (step 310), then the flash memory controller 210 simultaneously accesses a plurality of data from at least one of the data pages of 224A, 224B, 224C, and 224D in the plurality of blocks based on the access command, wherein the plurality of accessed blocks are on the same plane of different dies of the flash memory, the size of the plurality of data is smaller than the size of the data page, and the plurality of accessed data are temporarily stored in the memory buffer areas 222A, 222B, 222C, and 222D of the memory buffer 222 at the same time (step 320). The data size of each data can be 4 KB. In other embodiments, the data size can also be designed in a size of 1 KB, 2 KB, or depending on the system design. However, in this embodiment, the size of the accessed data is smaller than the size of the data page. When the access is finished, the flash memory controller 210 would control to temporarily store the plurality of data temporarily stored in the memory buffer areas 222A, 222B, 222C, and 222D of the memory buffer 222 to the controller buffer areas 213A, 213B, 213C, 213D of the controller buffer 213 of the flash memory controller 210 (step 330).

Referring to FIG. 3, specifically, at the same time, according to the access command, the flash memory controller 210 accesses a first data from a data page M of the block 224A in the flash memory 220 and temporarily stores the first data to the memory buffer area 222A in the flash memory 220, accesses a second data from a data page N of the block 224B in the flash memory 220 and temporarily stores the second data to the memory buffer area 222B in the flash memory 220, accesses a third data from a data page O of the block 224C in the flash memory 220 and temporarily stores the third data to the memory buffer area 222C in the flash memory 220, and accesses a fourth data from a data page P of the block 224D in the flash memory 220 and temporarily stores the fourth data to the memory buffer area 222D of the flash memory 220. Although this embodiment shows four data as examples, the number of accessed data for every single access command can be practically configured according to actual requirements. In the prior art, the four data accessing is based on the accessing outcome which is stored in the buffer area. Since the size of the data accessed each time is smaller than the size of the data page, to complete a data page accessing, the previous data must be completely accessed. However, the accessing of the present disclosure is performed at the same time, particularly the plurality of blocks to be accessed are on the same plane of different dies of the flash memory.

When the accessing is completed, the flash memory controller 210 would store the data temporarily stored in the memory buffer areas 222A, 222B, 222C, and 222D of the flash memory 220 to the controller buffer areas 213A, 213B, 213C, 213D of the controller buffer 213 in the flash memory controller 210.

Different from the prior art, when accessing data, in the prior art, the data of the data page M in the block 224A is first accessed to temporarily store to the memory buffer 222 of the flash memory 220, followed by being stored to the controller buffer 213 of flash memory controller 210. In every data accessing, it is necessary to wait until the previously accessed data is stored to the buffer area of the flash memory controller 210 before continuing to access the next data, thus the whole process of accessing takes up a lot of time with low efficiency. In the flash memory data accessing method of the present disclosure, all the accessed data are first temporarily stored in the buffer area in the flash memory 220, then access the accessed data to the buffer area of the flash memory controller 210 at a time when the data access is completed. In this way, the access efficiency of the memory can be improved.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A method for accessing a flash memory, the flash memory being electrically connected to a host device through a flash memory controller, the flash memory comprising a memory buffer and a plurality of blocks, each of the plurality of blocks comprising a plurality of data pages, the memory buffer of the flash memory comprising a plurality of memory buffer areas, each of the plurality of blocks comprising a plurality of data pages, the flash memory controller comprising a controller buffer, the controller buffer of the flash memory controller comprising a plurality of controller buffer areas, the method for accessing flash memory comprising:
the flash memory controller receiving an accessing command from the host device;
based on the accessing command, simultaneously accessing a plurality of data from at least one of the plurality of data pages in the plurality of blocks, wherein the accessed plurality of blocks is on the same plane of different dies of the flash memory, the size of the plurality of data is smaller than the size of the data page; and simultaneously caching the accessed plurality of data to the plurality of memory buffer areas of the memory buffer of the flash memory; and
accessing the plurality of data temporarily stored in the plurality of memory buffer areas of the memory buffer of the flash memory into the controller buffer area of the controller buffer of the flash memory controller at a time.

2. The method for accessing a flash memory according to claim 1, wherein the data size of each of the plurality of data is 1 KB, 2 KB, or 4 KB.

3. A flash memory controller, wherein the flash memory controller accesses a flash memory; the flash memory comprises a memory buffer and a plurality of blocks; the memory buffer comprises a plurality of memory buffer areas; each of the blocks comprises a plurality of data pages; the flash memory controller comprises a read only memory storing a program code and a processing circuit executing the program code to control the access to the flash memory; wherein the processing circuit:
receive an access command from a host device;
based on the accessing command, simultaneously access a plurality of data from at least one of the plurality of data pages in the plurality of blocks, wherein the accessed plurality of blocks is on the same plane of different dies of the flash memory, the size of the plurality of data is smaller than the size of the data page; and simultaneously and temporarily store the accessed plurality of data to the plurality of memory buffer areas of the memory buffer of the flash memory in order; and
access the plurality of data temporarily stored in the plurality of memory buffer areas of the memory buffer of the flash memory into the controller buffer area of the controller buffer of the flash memory controller at a time.

4. The flash memory controller according to claim 3, wherein the data size of each of the plurality of data is 1 KB, 2 KB, or 4 KB.

5. An electronic device, comprising a flash memory and a flash memory controller, the flash memory controller accessing the flash memory, the flash memory comprising a memory buffer and a plurality of blocks, the memory buffer comprising a plurality of memory buffer areas, each of the blocks comprising a plurality of data pages; the flash memory controller comprising a controller buffer, the controller buffer of the flash memory controller comprising a plurality of controller buffer areas, wherein the flash memory controller:
receive an access command from a host device;
based on the accessing command, simultaneously accessing a plurality of data from at least one of the plurality of data pages in the plurality of blocks, wherein the accessed plurality of blocks is on the same plane of different dies of the flash memory, the size of the plurality of data is smaller than the size of the data page; and simultaneously caching the accessed plurality of data to the plurality of memory buffer areas of the memory buffer of the flash memory; and
access the plurality of data temporarily stored in the plurality of memory buffer areas of the memory buffer of the flash memory into the controller buffer area of the controller buffer of the flash memory controller at a time.

6. The electronic device according to claim 5, wherein the data size of each of the plurality of data is 1 KB, 2 KB, or 4 KB.
